(19) United States
(12) Patent Application Publication
(10) Pub. No.: US 2002/0044135 A1
(43) Pub. Date: Apr. 18, 2002

(54) Positioning mechanism cooperative with track ball in mouse used for electronic device

(76) Inventor: Meng-Yu Wei, Taipei (TW)

Correspondence Address: ROTHWELL, FIGG, ERNST & MANBECK, P.C., 555 13TH STREET, N.W., SUITE 701, EAST TOWER, WASHINGTON, DC, 20004, US

(21) Appl. No.: 09/964,867

(22) Filed: Sep. 28, 2001

(30) Foreign Application Priority Data
Sep. 29, 2000 (TW) 089216897

(51) Int. Cl. G09G 5/08

(52) U.S. Cl. 345/163

(57) ABSTRACT

A positioning mechanism cooperative with a track ball in a mouse used for an electronic device is proposed, in which a positioning element retained in a housing is capable of being rotated by 360 degrees, and constantly in contact with the track ball by a resilient force provided from a resilient element. The positioning mechanism is advantageous of having the position element able to be perfectly cooperative with the movement of the track ball in the mouse, so that the flexibility in operation and accuracy in positioning of the track ball are both significantly improved.

### FIELD OF THE INVENTION

The present invention relates to positioning mechanisms provided in mice used for electronic devices, and more particularly, to a positioning mechanism cooperative with a track ball in a mouse used for an electronic device, in which a positioning element capable of being rotated by 360 degrees can be perfectly cooperative with the movement of the track ball, so as to minimize interference and improve flexibility and accuracy in movement of the track ball.

### BACKGROUND OF THE INVENTION

In recent years, with industrial and technological development, computers have become part of human life. Every family or even every individual is provided with a computer for work or entertainment purpose; therefore, computers are closely associated with modern human life. As computer software is commonly designed with windows, a mouse then plays an important role in operating the software through the windows. However, a conventional mouse is defective for several drawbacks, such as unsatisfactory flexibility in movement of the mouse, difficulty in accurately positioning a track ball in the mouse, and so on. FIG. 1 illustrates a conventional mouse structure, wherein this conventional mouse is mainly composed of a photoelectric element A, an X axial light fence wheel stick B, a Y axial light fence wheel stick C, a track ball D and a compressed wheel E. The compressed wheel E, that is resiliently pressed by a resilient element F, can press the track ball D toward the X and Y axial light fence wheel sticks B, C, so that the X and Y axial light fence wheel sticks B, C can be driven to rotate by the track ball D during rotation. With a resilient force provided from the resilient element F, the compressed wheel E is constantly in contact with the track ball D. The photoelectric element A measures the rotation magnitude that is represented by a signal generated from the photoelectric element A, so as to control the movement of a pointer of the mouse. However, the compressed wheel E is incapable of being rotated by 360 degrees. When the track ball D moves in a direction shown in FIG. 2A, the compressed wheel E can be coordinately rotated with the track ball D. On the other hand, if the track ball D moves in a direct shown in FIG. 2B, the compressed wheel E fails to properly operate in compliance with the rotation of the track ball D. This accordingly impairs and interferes with the movement of the track ball D, leading to difficulty in rotation or even frictional damage to the track ball D. This thereby significantly reduces the flexibility in movement of the mouse after a period of time in usage. Therefore, if the track ball D occurs to have difficulty in movement, the pointed of the mouse shown on a screen cannot be smoothly manipulated; this seriously degrades the operational quality of the mouse. In the case of FIG. 2B, since relatively greater interference would be produced between the compressed wheel E and the tack ball D, the compressed wheel E is easily surface-damaged. This not only undesirably affects the functionality of the compressed wheel E, but also deteriorates the balance in driving the rotation of the X and Y axial light fence wheel sticks B, C respectively, therefore resulting in inaccuracy of movement or positioning of the track ball D.

### SUMMARY OF THE INVENTION

A primary objective of the present invention is to provide a positioning mechanism cooperative with a track ball in a mouse used for an electronic device, so as to assure the flexibility in movement and accuracy in positioning of the track ball.

In accordance with the above and other objectives, the present invention proposes a positioning mechanism cooperative with a track ball in a mouse used for an electronic device, comprising: a positioning element capable of being rotated by 360 degrees in response to movement of the track ball; a housing mounted in the mouse for retaining the positioning element, the housing being formed with a plurality of protrusions on an inner surface of the housing so as to minimize interference generated by the housing against the positioning element; and a resilient element mounted in the housing for resiliently pressing the positioning element toward an opening formed on the housing, to an extent that a predetermined portion of the positioning element is protruded from the opening, so as to allow the positioning element to be constantly in contact with the track ball by a resilient force provided from the resilient element.

The positioning mechanism is further composed of a sliding block disposed between the positioning element and the resilient element, with a plurality of convex portions being formed on a surface of the sliding block in contact with the positioning element, so as to minimize interference caused by the sliding block against the positioning element.

Moreover, the housing of the positioning mechanism is further attached with a stopper having a hole corresponding in position to the opening and being smaller in diameter than the positioning element, such that the positioning element is prevented from escaping from the housing via the hole of the stopper.

The invention is advantageous of having the position element of the positioning mechanism capable of being perfectly cooperative with the movement of the track ball in the mouse, so that the flexibility in operation and accuracy in positioning of the track ball are both significantly improved.

### BRIEF DESCRIPTION OF THE DRAWINGS

The present invention can be more fully understood by reading the following detailed description of the preferred embodiments, with reference made to the accompanying drawings, wherein:

FIG. 1 (PRIOR ART) is a schematic diagram illustrating a conventional mouse structure;

FIGS. 2A and 2B (PRIOR ART) are schematic diagrams illustrating the correlation in movement between a track ball and a compressed wheel;

FIG. 3 is a perspective dissection view of a mouse with a positioning mechanism of the invention;

FIG. 4 is a perspective schematic diagram illustrating a mouse with a positioning mechanism of the invention;

FIG. 5 is a schematic diagram illustrating a track ball and a positioning mechanism of the invention;

FIG. 6 is a cross-sectional view of a track ball and a positioning mechanism of the invention;

FIG. 7 is a schematic diagram illustrating another embodiment of a mouse with a positioning mechanism of the invention;

FIG. 8 is a schematic diagram illustrating another embodiment of a fixing mechanism for fixing a positioning mechanism of the invention onto a base of a mouse;

FIG. 9 is a schematic diagram illustrating a further embodiment of a positioning mechanism of the invention;

FIG. 10 is a schematic diagram illustrating a housing, a sliding block and a positioning element of the invention;

FIG. 11A is a cross-sectional view of another embodiment of a sliding block of the invention;

FIG. 11B is a perspective view of a further embodiment of a sliding block of the invention;

FIG. 12 is a schematic diagram illustrating a further embodiment of a sliding block of the invention; and

FIG. 13 is a schematic diagram illustrating a further embodiment of a positioning mechanism of the invention.

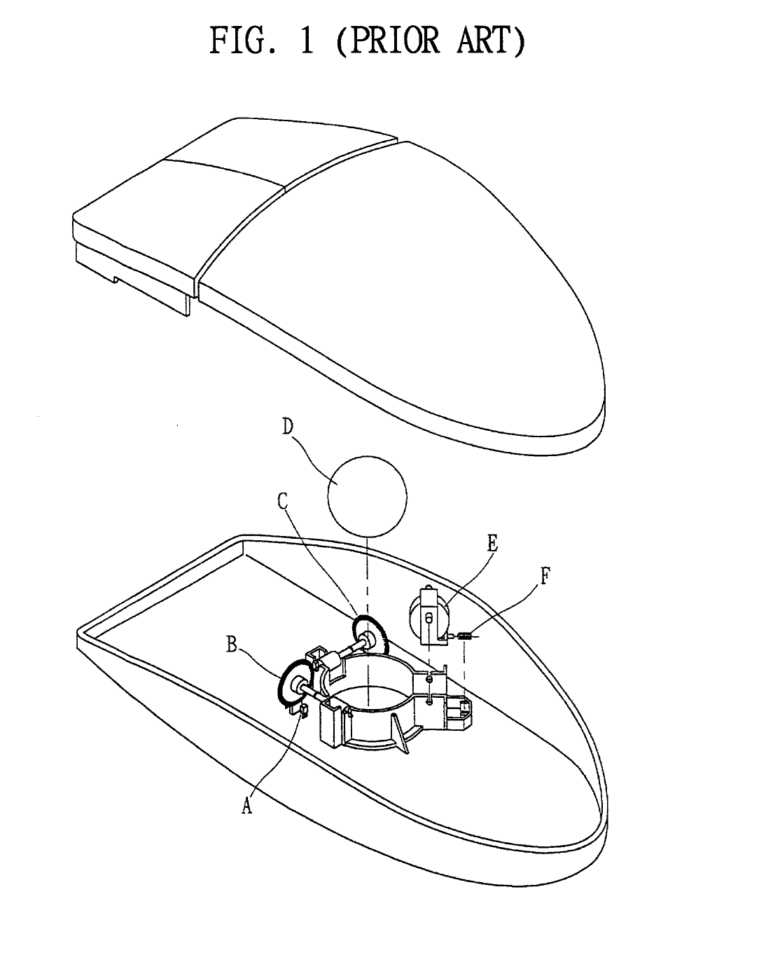

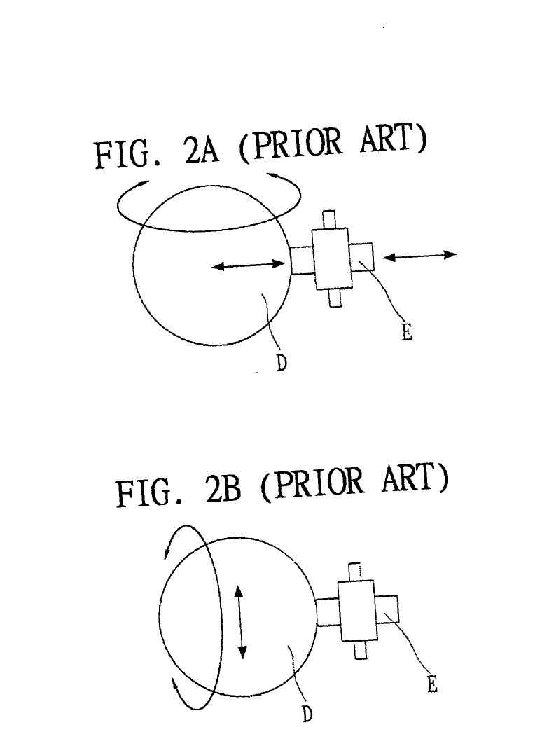

### DETAILED DESCRIPTION OF THE PREFERRED EMBODIMENTS

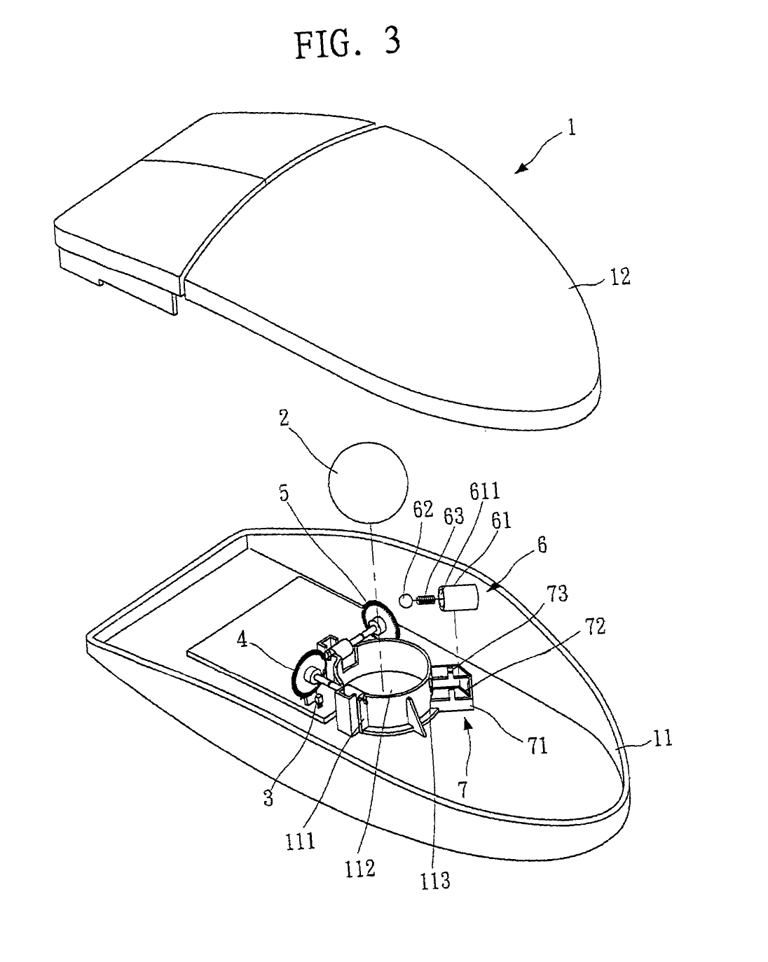

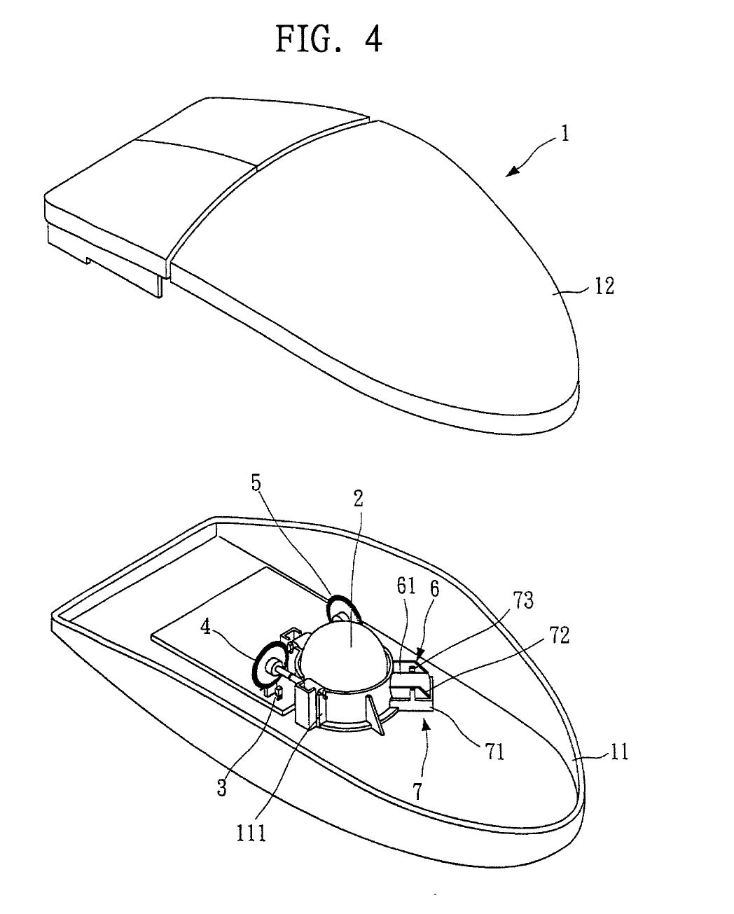

Referring to FIG. 3, it illustrates a perspective dissection view of a mouse with a positioning mechanism of the present invention. The mouse with the positioning mechanism of the invention comprises: a body 1, a track ball 2, a photoelectric element 3, an X axial light fence wheel stick 4, a Y axial light fence wheel stick 5 and a positioning mechanism 6. The body 1 of the mouse is composed of a base 11 and a cover 12, with a plurality of supporting elements 111 and a receiving cavity 112 for retaining the track ball 2 being formed on the base 11. The photoelectric element 3 is mounted on the base 11, and the X and Y axial light fence wheel sticks 4, 5 are pivotally disposed on the supporting elements 111. Such a mouse is characterized of employing the positioning mechanism 6, which includes: a housing 61, a positioning ball 62 and a resilient element 63. The housing 61 for retaining the positioning ball 62 is fixed onto the base 11 by means of a fixing mechanism 7, and formed at one end thereof with a retaining cavity 611, allowing the resilient element 63 and positioning ball 62 to be in turn placed into the retaining cavity 611 of the housing 61. Further, at a side wall of the receiving cavity 112 there is formed a through hole 113 dimensionally smaller in diameter than the positioning ball 62, allowing the positioning ball 62 to be pressed outwardly to abut against the track ball 2 by a resilient force provided from the resilient element 63. In the use of the positioning mechanism 6, the positioning ball 62 capable of being rotated by 360 degrees can be coordinately rotated with the track ball 2, so that the track ball 2 can be assured with smoothness in movement.

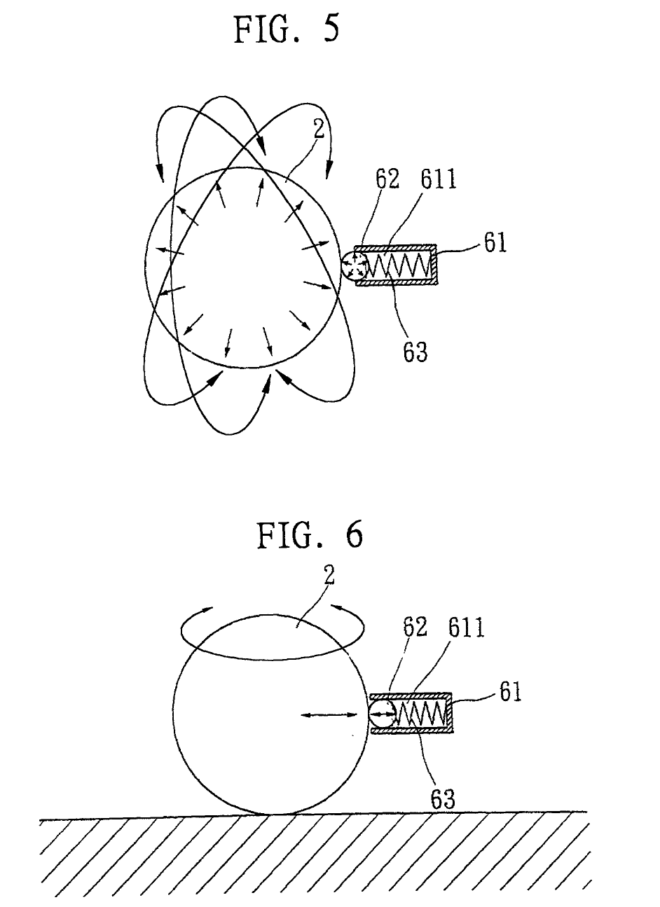

As described above, in the positioning mechanism 6 of the invention, the positioning ball 62 abuts against the track ball 2 by means of the resilient force from the resilient element 63, allowing the track ball 2 to be constantly in contact with the X and Y axial light fence wheel sticks 4, 5. On the other hand, as shown in FIG. 5, the positioning ball 62 can coordinate with the rotation of the track ball 2 in all directions. This thereby eliminates the problem in the prior art of frictional damage to the track ball D due to improper cooperation in movement between the compressed wheel E and the track ball D. Therefore, the invention is advantageous of significantly improving the operational quality of the track ball 2 and the mouse.

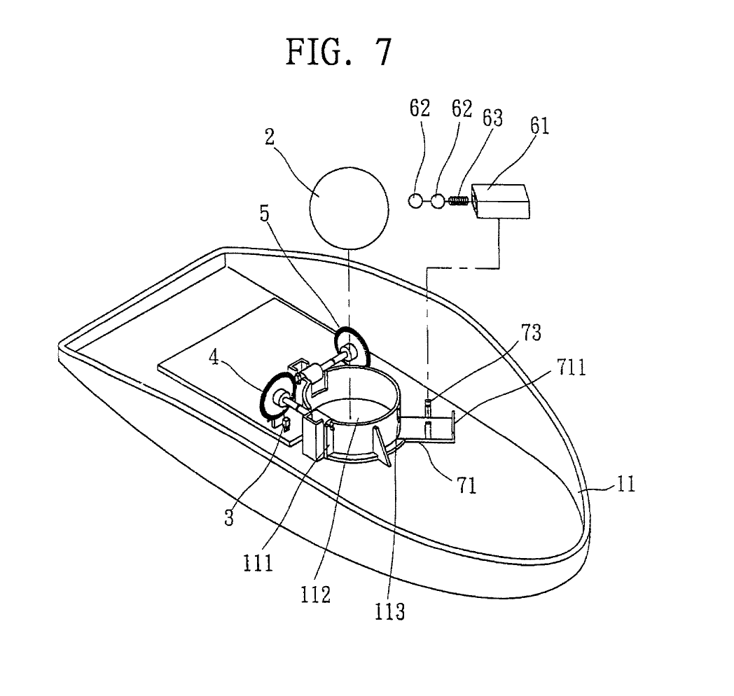

In the foregoing structure, the number of the positioning ball 62 can be one or more than one. For example, as shown in FIG. 7, two positioning balls 62 are provided and arranged in series within the housing 61. Since the positioning ball 62 keeps in constant contact with the track ball 2, when the mouse is operated, the track ball 2 rotates and presses on the positioning ball 62 that accordingly applies a force to the resilient element 63, and then the resilient element 63 responds with a resilient force to the positioning ball 62. This force interaction among the track ball 2, the positioning ball 62 and the resilient element 63 is horizontally proceeded at the same elevation, as shown in FIG. 6. Thus, the positioning ball 62 can keep operating at a horizontal direction of straight-line movement, and pressing the track ball 2 at the same position thereof, without causing instability to the movement of the track ball 2. The smoothly rotated track ball 2 can therefore evenly drive the rotation of the X and Y axial light fence wheel sticks 4, 5 respectively, thereby making the flexibility in operation and accuracy in movement of the mouse significantly enhanced.

Moreover, in the positioning mechanism 6 of the invention, the housing 61 is fixed onto the base 11 of the mouse by the fixing mechanism 7. The fixing mechanism 7 is composed of a fixing base 71 disposed on the base 11. The fixing base 71 is formed at its top surface with a recessed portion 72, and a bottom surface of the recessed portion 72 is dimensioned or shaped in compliance with the configuration of the housing 61. The fixing base 71 is further formed at its two sides with coupling elements 73, allowing the housing 61 retaining the resilient element 63 and the positioning ball 62 to be disposed on the fixing base 71 and held in position by the coupling elements 73. Alternatively, the housing 61 can be integrally formed with the base 11 of the mouse.

It is understood that, the resilient element 63 of the positioning mechanism 6 can be a compressed spring or an elastic body made of elastomer. The housing 61 is not particularly limited in shape, and can be made in response to the shape of the retaining cavity 611, such as circular or other shapes.

Referring to FIG. 7, in the foregoing fixing mechanism 7, the fixing base 71 can be further formed at its back end with a block 711, allowing the block 711 to be cooperative with the coupling elements 73 for firmly holding the housing 61 in position.

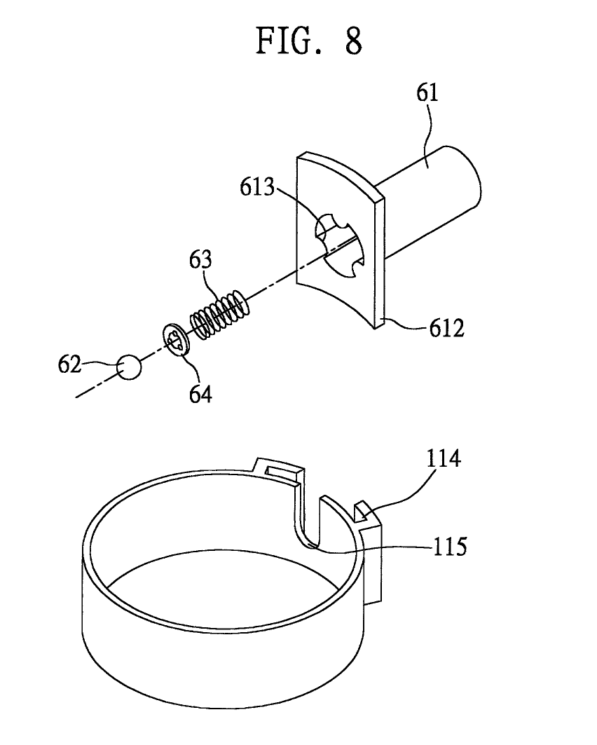

Referring to FIG. 8, further in the positioning mechanism 6, the housing 61 can be attached with a stopper 612 having a hole dimensionally smaller in diameter than the positioning ball 62, such that the positioning ball 62 is prevented from escaping from the housing 61 via the hole of the stopper 612. Accordingly, a groove 114 is formed correspondingly in position on the side wall of the receiving cavity 112, and dimensioned to be coupled to the stopper 612 of the housing 61, so as to further support the housing 61 in place.

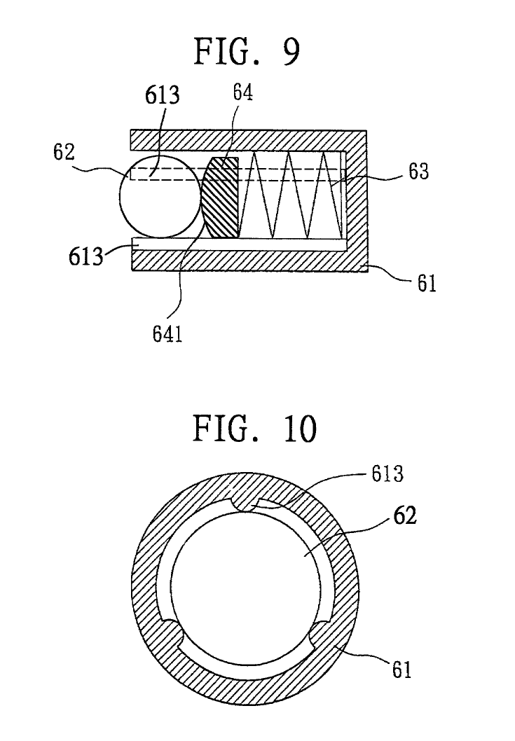

Referring to FIG. 9, when the positioning ball 62 and the resilient element 63 are both retained in the housing 61, a sliding block 64 is disposed between the positing ball 62 and the resilient element 63. Moreover, a plurality of protrusions 613 can be formed on an inner surface of the retaining cavity 611 of the housing 61, so as to minimize interference between the sliding block 64 and the retaining cavity 611, as shown in FIG. 10.

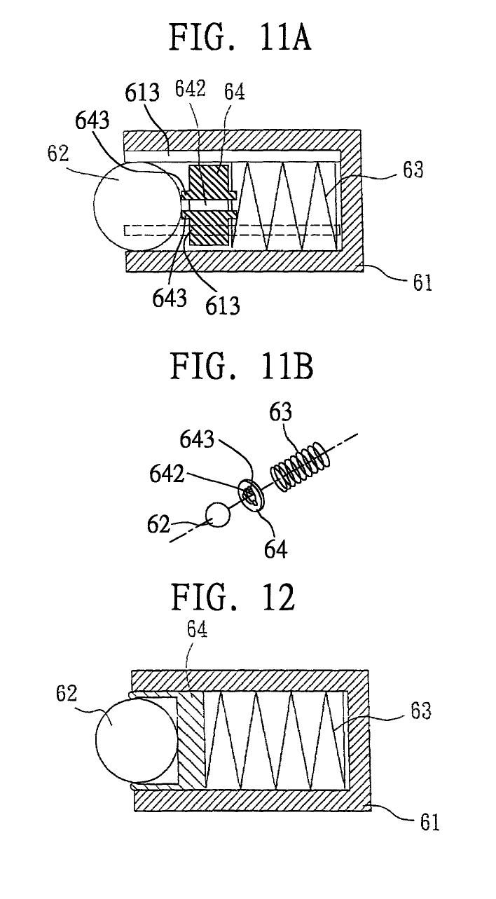

In order to effectively reduce interference caused by the sliding block 64 against the positioning ball 62, an arc surface 641 can be formed at an end of the sliding block 64 in contact with the positioning ball 62 (as shown in FIG. 9), or a recessed portion or through hole 642 is formed at a central position of the sliding block 64 (as shown in FIG. 11A), or a plurality of convex portions 643 are formed on a surface of the sliding block 64 in contact with the positioning ball 62 (as shown in FIG. 11B). In addition, referring to FIG. 12, the sliding block 64 can appear to be of a U shape, which allows three-point contact with the positioning ball 62.

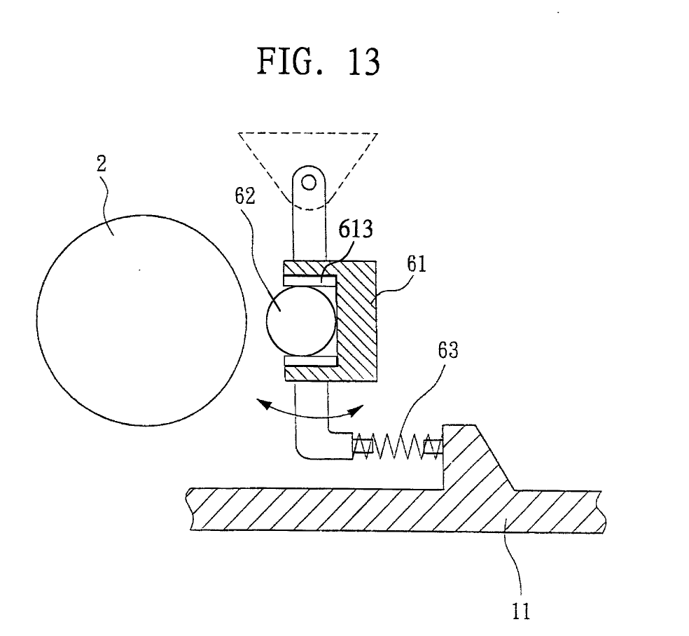

Finally, referring to FIG. 13, it illustrates an alternative embodiment of the positioning mechanism 6 of the invention. This embodiment is characterized in a manner that, the housing 61 only retaining the positioning ball 62 is pivotally mounted on the base 11, with the resilient element 63 being externally connected to the housing 61 and providing the resilient force to press the housing 61 forward, so as to make the positioning ball 62 in the housing 61 abut against the track ball 2 for facilitating the movement and positioning of the track ball 2.

In conclusion, the mouse with the positioning mechanism of the invention is advantageous with its simplicity in structure and convenience in use, in a manner that the position ball of the positioning mechanism can be perfectly cooperative with the movement of the track ball in the mouse, so that the flexibility in operation and accuracy in positioning of the track ball are both significantly improved.

The invention has been described using exemplary preferred embodiments. However, it is to be understood that the scope of the invention is not limited to the disclosed embodiments. On the contrary, it is intended to cover various modifications and similar arrangements, for example, the number of the positioning ball 62 or the shape of the housing 61 can be alternatively varied depending on practical requirements. The scope of the claims, therefore, should be accorded the broadest interpretation so as to encompass all such modifications and similar arrangements.

What is claimed is:

1. A positioning mechanism cooperative with a track ball in a mouse used for an electronic device, comprising:
a positioning element capable of being rotated by 360 degrees in response to movement of the track ball;
a housing mounted in the mouse for retaining the positioning element, the housing being formed with a plurality of protrusions on an inner surface of the housing so as to minimize interference generated by the housing against the positioning element; and
a resilient element mounted in the housing for resiliently pressing the positioning element toward an opening formed on the housing, to an extent that a predetermined portion of the positioning element is protruded from the opening, so as to allow the positioning element to be constantly in contact with the track ball by a resilient force provided from the resilient element.

2. The positioning mechanism of claim 1, wherein the resilient element is a compressed spring.

3. The positioning mechanism of claim 1, wherein the resilient element is an elastic body made of elastomer.

4. The positioning mechanism of claim 1, wherein the positioning element is a spherical body.

5. The positioning mechanism of claim 1, wherein the housing is mounted in a body of the mouse at a position equally spaced from an X axial light fence wheel stick and a Y axial light fence wheel stick operatively cooperative with the track ball.

6. The positioning mechanism of claim 1, wherein the housing is integrally formed in a body of the mouse.

7. The positioning mechanism of claim 1, wherein a sliding block is further disposed between the positioning element and the resilient element.

8. The positioning mechanism of claim 7, wherein a plurality of convex portions are formed on a surface of the sliding block in contact with the positioning element, so as to minimize interference caused by the sliding block against the positioning element.

9. The positioning mechanism of claim 1, wherein the opening of the housing is dimensioned to be smaller in diameter than the positioning element, so to prevent the positioning element from escaping from the housing via the opening.

10. The positioning mechanism of claim 1, wherein the housing is further attached with a stopper having a hole corresponding in position to the opening and being smaller in diameter than the positioning element, such that the positioning element is prevented from escaping from the housing via the hole of the stopper.

11. The positioning mechanism of claim 10, wherein a plurality of contact protrusions are formed around a rim of the hole of the stopper.

12. A positioning mechanism cooperative with a track ball in a mouse used for an electronic device, comprising:
a positioning element capable of being rotated by 360 degrees in response to movement of the track ball;
a housing mounted in the mouse for retaining the positioning element, the housing being formed with a plurality of protrusions on an inner surface of the housing so as to minimize interference generated by the housing against the positioning element; and
a resilient element mounted in a body of the mouse and resiliently coupled to the housing for providing a resilient force to the housing so as to urge the positioning element via the housing to constantly abut against the track ball.

13. The positioning mechanism of claim 12, wherein the resilient element is a compressed spring.

14. The positioning mechanism of claim 12, wherein the resilient element is an elastic body made of elastomer.

15. The positioning mechanism of claim 12, wherein the positioning element is a spherical body.
